(19) United States
(12) Patent Application Publication
(10) Pub. No.: US 2009/0021833 A1
(43) Pub. Date: Jan. 22, 2009

(54) CHROMOMODAL DISPERSION APPARATUS AND METHODS

(75) Inventors: Bahram Jalali, Los Angeles, CA (US); Todd Sienicki, Los Angeles, CA (US)

Correspondence Address: JOHN P. O'BANION;O'BANION & RITCHEY LLP, 400 CAPITOL MALL SUITE 1550, SACRAMENTO, CA, 95814, US

(73) Assignee: THE REGENTS OF THE UNIVERSITY OF CALIFORNIA, Oakland, CA (US)

(21) Appl. No.: 11/682,301

(22) Filed: Mar. 5, 2007

Related U.S. Application Data
(63) Continuation of application No. PCT/US05/32126, filed on Sep. 7, 2005.
(60) Provisional application No. 60/607,793, filed on Sep. 7, 2004.

(51) Int. Cl. G02B 5/18

(52) U.S. Cl. 359/570

(57) ABSTRACT

A system and method to chromomodally generate dispersion in light waves. The system and method may be used to control dispersive effects of an optical element such as a single-mode fiber. A light beam from the optical element is first collimated and then directed on to a spatially diffractive element where it is spatially dispersed into various chromatic frequency components. This frequency-separated light is then imparted onto a dispersion slope equalizer, and then passed into a highly multimode waveguide, where it is further dispersed. The light is then collected and focused back into an outgoing fiber-optic or other optical device.

### CROSS-REFERENCE TO RELATED APPLICATIONS

This application claims priority from, and is a 35 U.S.C. § 111(a) continuation of, co-pending PCT international application serial number PCT/US2005/032126, filed on Sep. 7, 2005, incorporated herein by reference in its entirety, which claims priority from U.S. provisional application Ser. No. 60/607,793, filed on Sep. 7, 2004, incorporated herein by reference in its entirety.

### INCORPORATION-BY-REFERENCE OF MATERIAL SUBMITTED ON A COMPACT DISC

Not Applicable

### STATEMENT REGARDING FEDERALLY SPONSORED RESEARCH OR DEVELOPMENT

This invention was made with Government support under Grant No. N66001-00-1-8035 and Grant No. N66001-98-1-8925 awarded by DARPA. The Government has certain rights in this invention.

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND OF THE INVENTION

1. Field of the Invention

This invention pertains generally to highly dispersive optical device, and more particularly to a chromomodal dispersive optical device.

2. Description of Related Art

Pulse propagation in dispersive media is one of the most highly researched areas in the optics and telecommunications industry. Since the late 1990's, advances in optics and telecommunications technology have provided better ways to increase capacity of optical networks. As the need for faster and more accurate data transmission arises, so does the need for more reliable optical networks capable of supporting this performance.

Dense Wavelength Division Multiplexing (DWDM) is one promising technique for future data flow needs. DWDM capacity is rapidly increasing by the inclusion of more channels, an increase in channel bit rate, and decreasing channel separation. The increase in channels at the expense of their spacing means that optical dispersion can have extremely deleterious effects upon communication by introducing pulse spreading. This pulse spreading often leads to Inter-Symbol Interference (ISI) and the loss of data in such networks. Thus, controlling dispersion effects in an optical system is crucial in maximizing its performance.

Many solutions have been developed to counteract the problem of dispersion in optical networks. Among passive components developed to address this problem by fiber-optic fabricators is the Dispersion Shifted Fiber (DSF), in which the zero crossing of the dispersion curve has been effectively shifted to occur at the corresponding point of least absorption in fused silica, the wavelength most commonly used for telecommunication. This unfortunately brings about the severe bottleneck in WDM systems of optical nonlinearities. Thus, the Non-Zero Dispersion Shifted Fiber has been developed at very low positive and negative dispersive values (±2 ps/nm*km). This is used in an alternating configuration where the total accumulated dispersion cancels out. Since the phase-matching condition is not satisfied along the propagation of the fiber, there is less of a problem with optical nonlinearities.

Another passive attempt at controlling dispersion is the Dispersion Compensating Fiber (DCF), which is a highly dispersive media that is able to compensate for accumulated dispersion in Single Mode Fiber (SMF) in 5-6 times shorter propagation distance. This is designed with a slope 5-6 times larger and opposite to that of SMF, so as to directly counteract the dispersive effects of normal propagation through a standard fiber. Thus, it is a not dispersion flattened apparatus and exhibits fairly large wavelength dependence and loss, in addition to its high dispersion value.

Dispersion Flattened Fiber (DFF) is another dispersion controlling device, which solves the dispersion slope issue. In DFF, the dispersion across the whole communications band has been flattened to achieve relatively low values for all wavelengths of interest. Thus, it achieves minimal higher-order effects, but at low dispersive values.

All of these passive devices attempt to minimize dispersion in optical communication. However, there may also be a need to maximize dispersion in a uniform method with little wavelength dependence. There has not been much of an effort to attain this result, since the general need for high dispersion centers around the cancellation of previous accumulated dispersion, such as in the DCF. Therefore, a high dispersion slope is typically created.

One possible application to a device with high dispersion and low dispersion slope is in pulse chirping and shaping. Chirping refers to the temporal pre-shaping of an optical pulse. Often times this is done by making high frequency components arrive first in a dispersive media, so that after normal dispersion occurs there is an overall pulse compression. In addition to this application, there is a general need to have the ability to engineer dispersion.

### BRIEF SUMMARY OF THE INVENTION

A tunable dispersion device is disclosed that attains high dispersion, low dispersion slope, and low loss performance by chromatically dispersing a light wave and creating modal dispersion of the dispersed light with a multimode waveguide. The results and implementation of this device are demonstrated through the use of the Zemax® optical design program (Zemax® is a registered trademark of the Zemax® Development Corporation). The present invention makes use of the chromatic dispersion of a diffraction grating and the modal dispersion of a waveguide to maximize and control the dispersion value, while minimizing higher-order dispersive effects, i.e. a chromomodal dispersion device. The device was tested in three versions: one completely free space version, and two versions in which a waveguide (glass and silicon) is used.

One aspect of the invention is an apparatus for chromatically dispersing a light wave. The apparatus includes a spatially diffractive element configured to chromatically disperse the light wave into a plurality of spectral components, and a multimode waveguide coupled to the spatially diffractive element. The multimode waveguide is configured to transform the dispersed light wave into a plurality of multimode waves corresponding to the plurality of spectral components.

In one embodiment, the multimode waveguide comprises an entrance port and an exit port, wherein the multimode waveguide propagates the multimode waves of each spectral component from the entrance port to the exit port so that multimode waves of different wavelengths arrive at the exit port at separate times.

In a preferred embodiment, a dispersion slope equalizer is positioned between the spatially diffractive element and the multimode waveguide. The dispersion slope equalizer is configured to flatten a dispersion curve corresponding to the multimode waves prior to directing the multimode waves into the entrance port of the multimode waveguide. In some embodiments, the dispersion slope equalizer comprises a curvilinear surface, e.g. a convex spherical surface.

In some embodiments, the dispersion slope equalizer removes at least some of the higher-order dispersion effects in the multimode waves. Where the higher-order dispersion effects comprise a non-uniform spread of multimode waves of different wavelengths, the dispersion slope equalizer controls the angular spread of the wavelengths. Preferably, the dispersion slope equalizer affects a substantially constant angular spread between the wavelengths to flatten the dispersion curve.

In one embodiment the spatially diffractive element comprises a diffraction grating. In addition, the multimode waveguide comprises at least two parallel inner surfaces, configured to reflect the plurality of multimode waves incident on said inner surfaces. Preferably, the multimode waveguide is configured such that the multimode waves are incident on the inner surfaces at a reflection angle θ. The reflection angle θ may be varied to change an enhancement factor for the dispersion between multimode waves of different wavelengths.

In a further embodiment, the orientation of the spatially diffractive element is adjustable to tune dispersion of the light wave.

Another aspect of the invention is an apparatus for controlling dispersive effects of a light wave traveling in an optical element. The apparatus comprises a spatially diffractive element configured to chromatically disperse the light wave into a plurality of spectral components, a multimode waveguide coupled to the spatially diffractive element, and a dispersion slope equalizer positioned between the spatially diffractive element and the multimode waveguide. The multimode waveguide is configured to transform the dispersed light wave into a plurality of multimode waves corresponding to the plurality of spectral components.

In one embodiment of the current aspect, the multimode waveguide has an entrance port and an exit port, and the multimode waves of each spectral component propagate from the entrance port to the exit port such that multimode waves of different wavelengths arrive at the exit port at separate times. Additionally, the dispersion slope equalizer is configured to flatten a dispersion curve corresponding to the multimode waves prior to directing the multimode waves into the entrance port of the multimode waveguide.

In one embodiment, the optical element comprises a first optical fiber. Where the light wave has dispersive effects as a result of traveling along the first optic fiber, the multimode waveguide is configured to counteract said dispersive effects. The apparatus may further have a collimating lens to collimate the light wave from the optical fiber to the dispersive element. Furthermore, an output coupling may be coupled to the multimode waveguide to collect and focus the multimode waves into a second optical fiber.

In a preferred embodiment, the multimode waveguide comprises at least two parallel inner surfaces configured to reflect the plurality of multimode waves incident on said inner surfaces. The multimode waves are incident on said inner surfaces at a reflection angle θ; which may be varied to change the enhancement factor for the dispersion between multimode waves of different wavelengths. Preferably, the angular orientation of the spatially diffractive element is adjustable to tune the dispersion enhancement factor. Generally, the reflection angle θ ranges between approximately 1.5 degrees and approximately 3 degrees. For some applications, the light wave has a wavelength ranging from approximately 1525 nm to approximately 1560 nm.

A further aspect of the invention is a method for chromatically dispersing a light wave, comprising directing the light wave at a spatially diffractive element, chromatically dispersing the light wave into a plurality of spectral components, and transforming the dispersed light wave into a plurality of multimode waves, wherein the plurality of multimode waves corresponding to the plurality of spectral components.

In many embodiments, the dispersed light wave is transformed into a plurality of multimode waves comprises by propagating each spectral component along a waveguide such that multimode waves of different wavelengths exit the waveguide at separate times.

Preferably, the dispersion curve corresponding to the multimode waves is flattened (e.g. removing higher-order dispersion effects) prior to propagating each spectral component. This generally comprises directing a chromatically dispersing the light wave at a curvilinear surface.

Where some of the higher-order dispersion effects comprise a non-uniform spread of multimode waves of different wavelengths, the angular spread of the wavelengths is controlled.

In a preferred embodiment, the method further includes adjusting an angular orientation of the chromatically dispersed light with respect to the waveguide to tune the dispersion of the light wave.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a diagram showing dispersive effects in a waveguide.

FIG. 2 schematically illustrates a cross-section of a multimode fiber.

FIG. 3 schematically illustrates single-mode fiber.

FIG. 4 illustrates a chromomodal dispersion device in accordance with the present invention.

FIG. 5 illustrates a diagram of the method of the present invention for chromomodal dispersion of a light wave.

FIG. 6 illustrates a schematic view of a waveguide in accordance with the present invention.

FIG. 7 shows a diagram of the length enhancement factor as a factor of the reflection angle in the multimode waveguide of the present invention.

FIG. 8A illustrates the angular dispersion as a function of wavelength prior to dispersion slope equalization in accordance with the present invention.

FIG. 8B illustrates the non-uniform angular spread at various wavelengths prior to dispersion slope equalization in accordance with the present invention.

FIG. 9 illustrates light wave propagation inside the multimode waveguide of the present invention.

FIG. 10 is a diagram comparing simulated results against theoretical values.

FIG. 11 illustrates a comparison of the dispersive properties of different waveguide materials.

FIG. 12 illustrates a comparison of the dispersion slope properties of different waveguide materials.

FIG. 13 illustrates a comparison of the dispersive properties of different waveguide materials using the method of the present invention as opposed to other dispersive elements.

FIG. 14 illustrates a comparison of the dispersion slope properties of different waveguide materials using the method of the present invention as opposed to other dispersive elements.

### DETAILED DESCRIPTION OF THE INVENTION

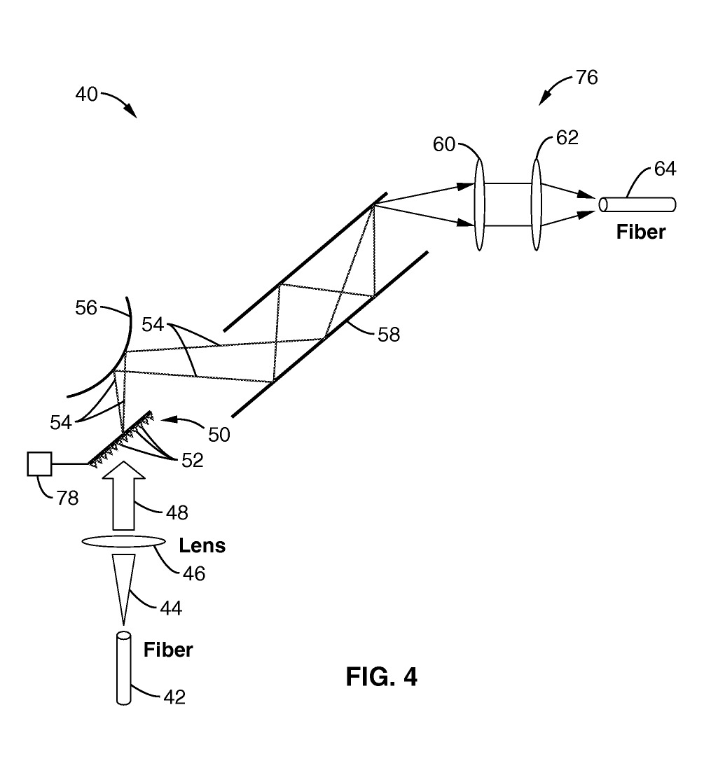

Referring more specifically to the drawings, for illustrative purposes the present invention is embodied in the apparatus generally shown in FIG. 4 through FIG. 14. It will be appreciated that the apparatus may vary as to configuration and as to details of the parts, and that the method may vary as to the specific steps and sequence, without departing from the basic concepts as disclosed herein.

1. Wave Dispersion in Optical Fibers

Dispersion, although often undesirable, is an effect that is inherent in nature and understanding of the mathematical and natural origins of this phenomenon is important in efforts to counteract it.

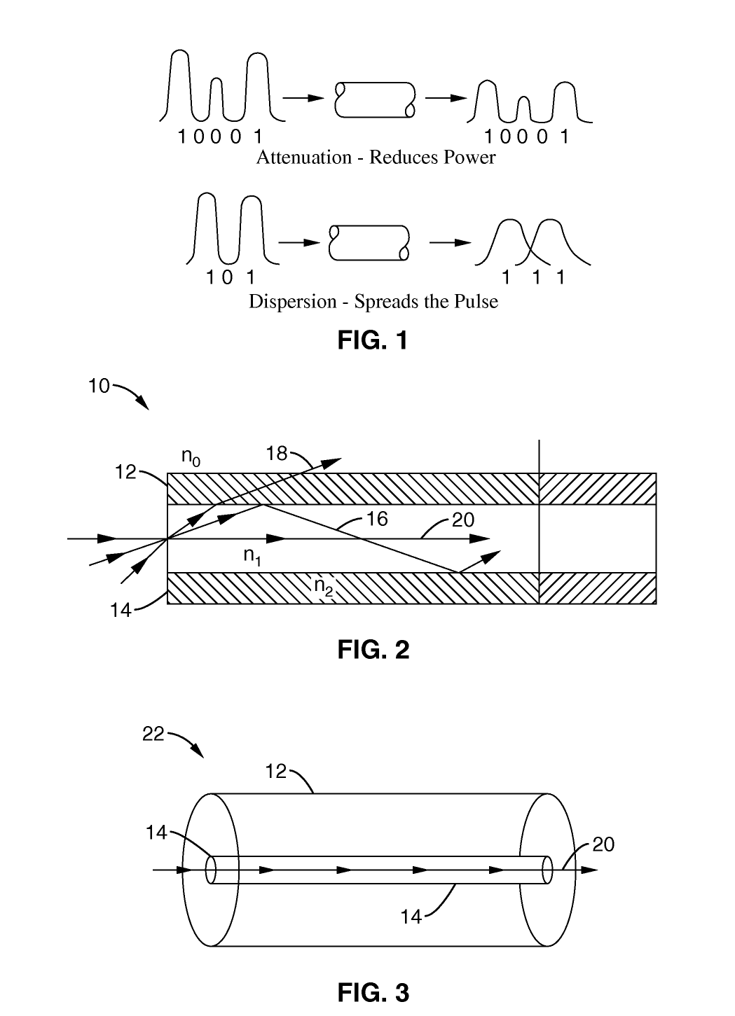

It is clear that the refractive index in a dispersive medium is frequency dependent, thus waves propagating with different frequencies will travel at different speeds. This has a very important effect upon data transmission. If it is assumes that information is contained in pulses, and if these pulses travel as truly monochromatic waves, dispersive effects would be negligible, since the profile in the frequency domain would be an impulse function. Since there would only be one frequency component, all waves involved would travel at exactly the same speed. However, this is an ideal case scenario and is nearly impossible to create. In reality, there will be some spectral shape to any pulse as it travels into a waveguide, meaning that it will be composed of the sum of multiple monochromatic waves and there will be the presence of many different frequency components (however narrowband the pulse may be). Since each one of these components will travel at a different speed and experience a different attenuation, the spectral pulse shape will broaden as it propagates through the medium, as depicted in FIG. 1. This effect is known as dispersion. As repetitive pulses are produced for data transfer and processing, this temporal spreading can cause overlapping of pulses and eventual loss of data.

There are generally two types of dispersion in optical fibers: intramodal or chromatic dispersion, and modal dispersion. The particular phenomenon in which different spectral components travel at different speeds is known as chromatic dispersion, and occurs in all types of fibers, including single-mode fibers and multimode fibers. Chromatic dispersion is typically broken up into two separate events, waveguide dispersion and material dispersion. Material dispersion is the aforementioned variation in the refractive index of a material with wavelength. Waveguide dispersion has to do with the confinement of light as it propagates in a waveguide, and for purposes of the present invention will be assumed negligible.

Modal dispersion refers to the propagation of light in a waveguide in modes and broadening of pulses due to the fact that different fiber modes travel at different effective speeds. This is only an issue in large core fibers in which many modes are present, referred to as multimode fibers.

FIGS. 2 and 3 illustrate the differences in the paths of light waves traveling through multimode vs. single-mode fibers. In the cross section of multimode fiber shown in FIG. 2, numerous modes or light rays are carried simultaneously through the waveguide 10. Modes result from the fact that light will only propagate in the fiber core 14 at discrete angles within the cone of acceptance. This fiber type has a much larger core diameter, compared to single-mode fiber, allowing for the larger number of modes, and multimode fiber is easier to couple than single-mode optical fiber.

FIG. 2 shows how the principle of total internal reflection applies to multimode step-index fiber. Because the core 14 index of refraction is higher than the cladding 12 index of refraction, the light that enters at less than the critical angle is guided along the fiber.

Three different light waves travel down the fiber. A first mode 20 travels straight down the center of the core 14. A second mode 16 travels at a steep angle and bounces back and forth by total internal reflection. The third mode 18 exceeds the critical angle and refracts into the cladding. Intuitively, it can be seen that the second mode travels a longer distance than the first mode, causing the two modes to arrive at separate times.

Single-mode fiber (SMF), as shown in FIG. 3, is a waveguide 22 characterized by a smaller core 14 and larger cladding 12, such that only one mode of light 20 passes straight down the center of the core 14. SMF allows for a higher capacity to transmit information because it can retain the fidelity of each light pulse over longer distances, and it exhibits no dispersion caused by multiple modes. SMF also enjoys lower fiber attenuation than multimode fiber. Thus, more information can be transmitted per unit of time. Therefore SMF is used widely wherever long transmission distances are needed. Although SMF is free of multi-mode dispersion, chromatic dispersion is still present, particularly in higher data rates and number of WDM channels.

2.0 Optical Design
2.1 High-level System Overview

The device and methods of the present invention, illustrated below in FIGS. 4-14, basically combine the chromatic dispersion of a spatially diffractive element with the modal dispersion of a highly multimode waveguide to control dispersion effects in optical systems to maximize performance.

Referring now to FIG. 4, a schematic view of a system 40 to control dispersive effects is illustrated in accordance with the present invention. Light path 44 originates from a fiber-optic link 42, and generally carries an optical signal having dispersive effects. For example, link 42 may be coupled to a single-mode fiber 22 as shown in FIG. 3.

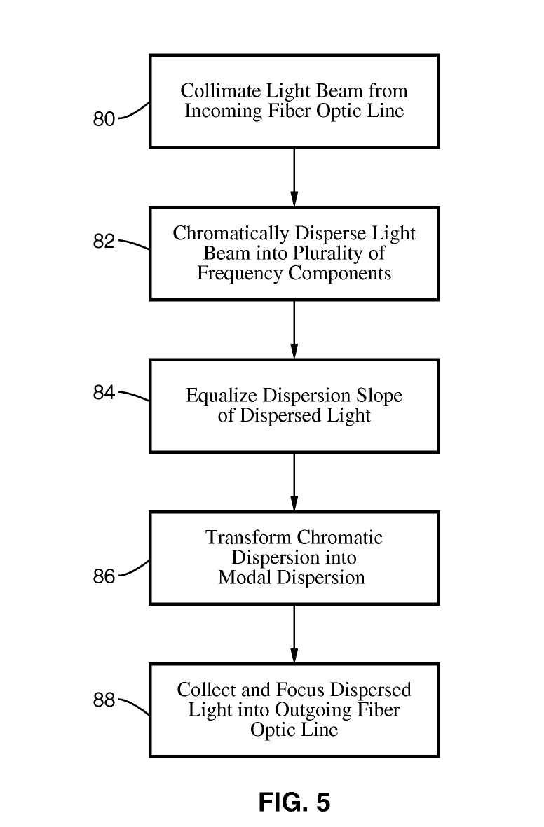

According to FIG. 4 and the method detailed in FIG. 5, the light beam 44 is first collimated (step 80) by lens 46 to generate a collimated beam 48. Beam 48 is then directed on to a spatially diffractive element 50 where it is spatially dispersed (diffracted) (step 80) into various chromatic frequency components 54. This frequency-separated light 54 is then imparted onto a dispersion slope equalizer 56 at step 84. Preferably, the dispersed light 54 is passed into a highly multimode waveguide 58, where it is further dispersed.

The light is then collected with output coupling 76. In one embodiment, output coupling 76 comprises lenses 60, 62 to collect the light from the waveguide 58, and focus it (with lens 62) back into an outgoing fiber-optic 64. Alternatively, output coupling 76 may comprise a grating and lens combination (not shown) similar to grating 50 and lens 46 positioned at the fiber-optic link 42, or similar collection devices known in the art.
2.2 Chromatic to Modal Dispersion

Chromatic dispersion is affected by the spatial diffraction element 50. Diffraction element 50 preferably comprises a diffraction grating, however may comprise any dispersive element commonly used in the art, e.g. prisms,

In mathematical terms, the dispersion is the change in time traveled with wavelength per unit length and then expanded by the chain rule to incorporate the angular separation given by the spatially diffractive element 50, and is modeled in Eq. (2.1).

$$D = \frac{1}{L} \frac{d τ}{d λ} = \frac{1}{L} \frac{d τ}{d θ} \frac{d θ}{d λ} \qquad ( 2.1 )$$

All light that passes into the system is assumed to be well collimated (e.g. via collimating lens 46 as shown in FIG. 4) before becoming incident upon the dispersive element. This collimated light then strikes a spatially dispersive element; e.g. the diffraction grating 50. The diffraction grating 50 is typically a small optical element of various materials and coatings which has ruled across its face a series of equally spaced grooves 52. There exists a unique set of discrete angles along which the diffracted light from each groove is in phase with the light diffracted from any other groove, so they combine constructively. The variation in wavelength of different light components causes this constructive interference to occur in different angular directions. Thus, the diffracted angle, β, is a function of the incident angle, α, wavelength, λ, and the groove spacing, d, as shown in the grating equation:

mλ=d(sin α+sinβ) (2.2)

where m is the diffraction order, an integer. Since, a low loss device is desirable, we will operate in the first order (m=±1), so there is only light lost to the zeroth order. The derivative of this equation, with respect to the wavelength, will give the angular dispersion, or change in angle per unit wavelength. Under the assumption that the incident angle is constant (a collimated beam):

$$\frac{\partial β}{\partial λ} = \frac{m}{d cos β} \qquad ( 2.3 )$$

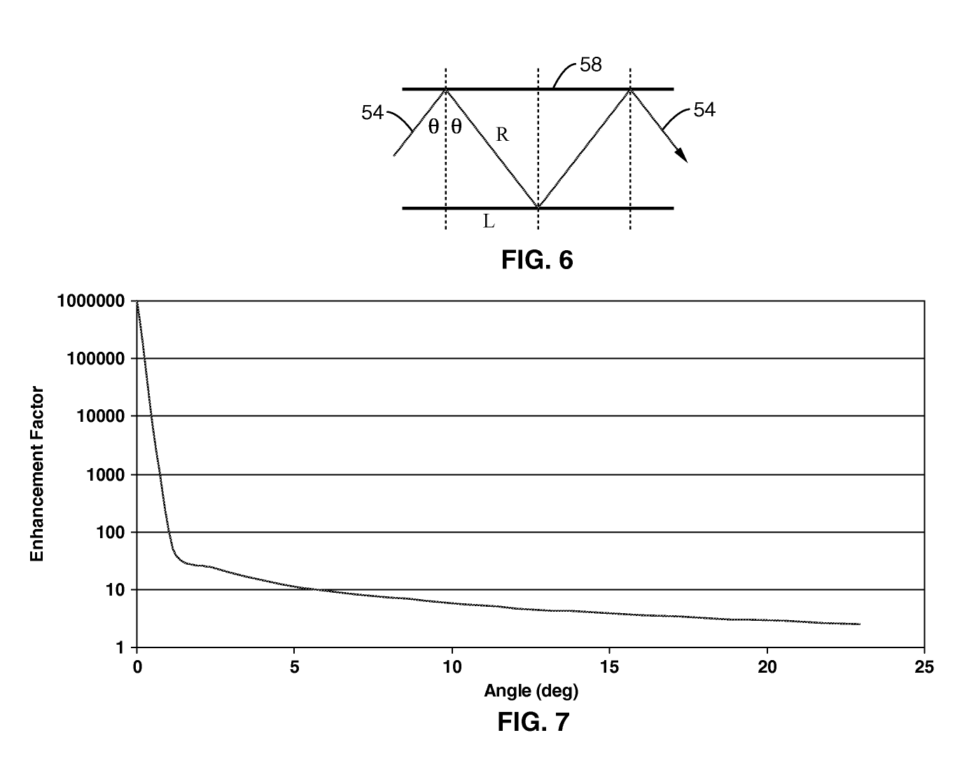

Once the light 48 has been chromatically separated into different spectral components 54, and temporarily ignoring the dispersion slope equalizer 56 (discussed below in greater detail), the light passes into a highly multimode waveguide 58. Since each spectral component 54 is passed with a unique angle, the waveguide 58 will effectively create the transfer of the chromatic dispersion into modal dispersion (step 86 in FIG. 5). This complicates the view of the propagation distance, since it is now wavelength dependent. Each wavelength 54 will enter the waveguide 58 to form a reflection angle, θ, which corresponds to the incidence of the light wave with the side surface or face of the waveguide 58 as depicted in FIG. 6.

There is consequently a multiplicative factor upon a unit length of propagation distance, L, which we will call the length enhancement factor, γ, and is characterized by Eq. (2.4).

$$γ ≡ \frac{R}{L} = {( sin θ )}^{- 1} \qquad ( 2.4 )$$

As apparent from Eq. (2.4), as the angle is reduced, the enhancement factor γ increases dramatically, which is further illustrated in FIG. 7. The time delay that each wavelength 54 experiences is a direct result of the enhancement to the length, L, traveled.

$$τ = \frac{n \cdot L \cdot γ}{c} \qquad ( 2.5 )$$

Therefore, a wavelength incident in the waveguide 58 with a larger length enhancement factor will take much more time to propagate along the optical axis. The initial dispersion equation may be revised to include this effect. Thus, by substitution of Eq. (2.5) into Eq. (2.1):

$$D = \frac{n}{c} \frac{d γ}{d θ} \frac{d θ}{d λ} \qquad ( 2.6 )$$

The change in enhancement factor with angle is obtained by differentiation of Eq. (2.4). Since is desirable to maximize the modal dispersion that will occur in the waveguide 58 (large length enhancement factor), we can assume a small angle and approximate it by:

$$\frac{d γ}{d θ} = - {γ}^{2} cos θ \approx - {γ}^{2} \qquad ( 2.7 )$$

This gives the resulting dispersion equation:

$$D = - \frac{n}{c} {γ}^{2} \frac{d θ}{d λ} \qquad ( 2.8 )$$

where substitution of Eq. (2.3) from the diffraction grating gives us the final term in Eq. (2.8), the angular dispersion.

As shown above, the enhancement factor and dispersion generated by the waveguide is highly dependent on the reflection angle θ. Thus, the device 40, and dispersion generated there from, is tunable by adjusting the orientation of the dispersive element (diffraction grating) 50. As shown in FIG. 4, adjustment means 78 may be coupled to the diffraction grating 50 to facilitate angular adjustment of the grating 50 and corresponding reflection angle θ. Adjustment means 78 may comprise a knob (not shown) that allows manual micro-adjustment of the angular orientation of the diffraction grating 50. Alternatively, adjustment means 78 may comprise a motorized actuator (not shown), such as a servo motor, linear actuator, or other actuator known in the art, to incrementally adjust the angular orientation of the diffraction grating 50. The motorized actuator may be computer controlled, with an algorithm or software controlling the angular orientation of the diffraction grating 50 according to a desired angle θ or dispersion value.
2.3 Higher Order Dispersion

Undesirable higher order dispersion, whereby the dispersion, D, changes with wavelength, may be obtained by differentiation of Eq. (2.8) to get:

$$\frac{d D}{d λ} = - \frac{n}{c} \frac{d }{d λ} ( {γ}^{2} \frac{d θ}{d λ} ) = - \frac{n}{c} [ \frac{d {γ}^{2}}{d λ} \frac{d θ}{d λ} + {γ}^{2} \frac{{d}^{2} θ}{d {λ}^{2}} ] \qquad ( 2.9 )$$

If the angular dispersion of the grating 58 is assumed to be constant, the second term vanishes. Hence, only the first term is calculated. Again by the chain rule,

$$\frac{d ( {γ}^{2} )}{d λ} = \frac{d ( {γ}^{2} )}{d θ} \frac{d θ}{d λ} \qquad ( 2.10 )$$

Obtaining the first part by differentiation and substitution of Eq. (2.8), results in:

$$\frac{d ( {γ}^{2} )}{d θ} = 2 γ \frac{d γ}{d θ} \approx - 2 {γ}^{3} \qquad ( 2.11 )$$

Substitution of Eq. (2.11) back into Eq. (2.10) and then back into Eq. (2.9) results in the final form for the wavelength dependence of the dispersion.

$$\frac{d D}{d λ} = 2 \frac{n}{c} {{γ}^{3} ( \frac{d θ}{d λ} )}^{2} \qquad ( 2.12 )$$

Since higher order effects are undesirable in the optical system, it is desirable to have a constant dispersion over the wavelength range in question. The present invention uses a dispersion slope compensator 56, described in further detail below, to flatten or equalize the slope of the dispersion versus wavelength curve (step 84 in FIG. 5).

3.0 CAD Simulation and Optimization

Zemax® optical design software was used to implement and optimize the design of the optical system 40. All relevant components, including glasses and coatings, were simulated.

The wavelength range must first be established. One of the preferred uses of the chromo-modal dispersion device 40 is as a broadband apparatus. Thus, the wavelengths that span the c-band telecommunications spectra range from approximately 1.525 μm to approximately 1.56 μm. Since only discrete wavelengths (a maximum of twelve) can be input into the software for ray tracing purposes, a number of eight wavelengths was chosen, each equally spaced in 5 nm increments.

To initiate the light incident into the system, the entrance pupil diameter was set to 1 mm to simulate the aperture of a single mode fiber. For simplicity in the simulation, an already collimated beam was assumed. Furthermore, the beam has defined a Gaussian apodization, with a nominal apodization factor of one. Since the simulation is run as a group of traced rays, which would preclude the possibility of a beam of Gaussian profile, this apodization calculates all rays as if they originated in a Gaussian distribution. This will then give the appearance and calculation of all relevant quantities as if a continuous beam had been launched with a Gaussian profile.

The first optical element that needs to be implemented in the simulated system is the diffraction grating 50. The placement of coordinate break surfaces before and after the grating were chosen to allow for the tilt and decentering of the grating from the default orthogonal and centered placement, with respect to the optical axis.

The diffraction grating surface 52 was modeled by several parameters, including lines per micron, diffraction order, radius of curvature, thickness, glass type, and semi-diameter. For a standard ruled grating there is no curvature and we will allow the semi-diameter to be set automatically by the software. Initially, a mirror glass type surface was applied to emulate a reflection grating (as opposed to a transmission grating), with the thickness set to a negative value to allow for propagation throughout the rest of the optics. The negative thickness value in Zemax® implies that the light will be moving in the negative direction along the optical axis, which is ideal when using a reflection grating. This thickness value is variable and capable of modification in later optimization routines.

The first order of the grating was used. Since the amount of angular dispersion increases as the groove spacing 52 decreases, (as indicated in Eq. (2.3)), a high-frequency grating pitch was chosen of 1.265 lines per micron.

As shown in FIG. 4, the newly wavelength-separated light 54 from the grating 50 strikes the dispersion slope equalizer 56. As indicated above, higher-order effects are undesirable in a dispersion-compensating device. Careful analysis of the components reveals that there are two main causes of the wavelength dependence of the dispersion: 1) the nonlinear behavior of the length enhancement factor and 2) the non-uniformity of the angular dispersion created by the diffraction grating 50. The former is apparent in FIG. 7, where the amount of length enhancement increases dramatically as the incident angle into the waveguide 58 is reduced. Thus, a constant angular spread between wavelengths does not equate to a constant induced modal dispersion between wavelengths in the waveguide 58.

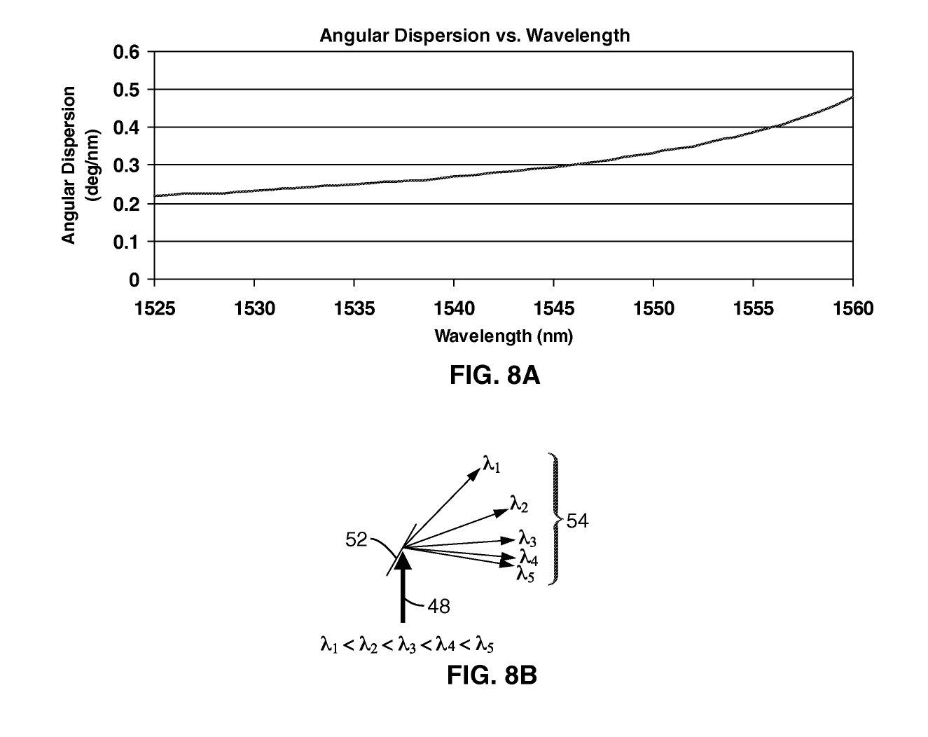

The second effect is a consequence of the properties of the grating 50. It implies that there is a further angular separation off the grating between higher wavelengths than between lower wavelengths. This is shown graphically, using an arbitrary input angle in FIG. 8A, and pictorially in FIG. 8B. The dispersion slope equalizer 56 counteracts the non-linearity of chromatic and modal dispersion. The dispersion slope equalizer 56 preferably comprises a curvilinear surface, such as a parabolic, ellipsoidal or spherical surface. For example, when the wavelength dispersed light 54 strikes a spherically convex mirror of appropriate curvature and positioning, the angular spread of the wavelengths is controlled, and consequently the dispersion curve is flattened.

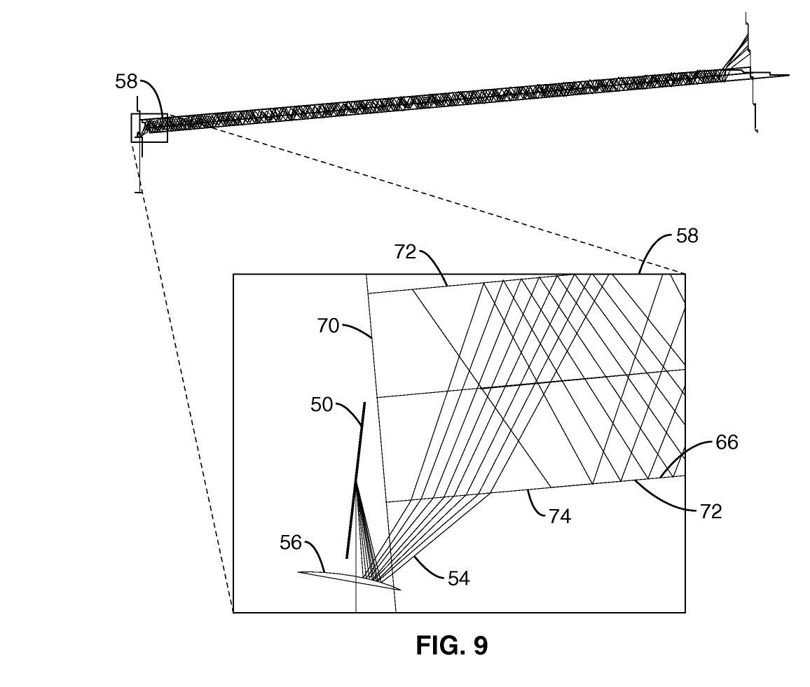

The final optical element of interest in the simulation is the waveguide 58 shown in the system diagram of FIG. 4, and a detailed component view in FIG. 9. The Zemax® system is used in a hybrid mode where all occurrences that take place before and after the waveguide 58 are sequential elements and the waveguide itself is a non-sequential element. The waveguide is non-sequential because the light strikes the same object (the inner walls of the waveguide side faces 72) repeatedly before moving to the next surface. For simulation, a 10 cm waveguide was used. The exit port 68 of the waveguide was set at an arbitrary distance after this, a total of 10.5 cm along the relative optical axis from the entrance port 70.

Simulations were performed on three different types of waveguides. All were designed to be highly multimode. Preferably, the side faces 72 are coated with coating 66 to eliminate any problems that would occur with total internal reflection due to the small angles of incidence on each side face 72. Coating 66 preferably comprises a high-reflection (HR) coating, such as a polished aluminum, silver or gold, to act as a mirror to reflect a large percentage, or substantially all, of the light waves. The first waveguide was modeled as a 2 mm wide hollow reflective tube (or equivalently as two parallel mirrors). The second waveguide was modeled as a glass substrate, and modeled using a rectangular volume surface in Zemax® with a standard glass, BK7, of refractive index, n≈1.5, and the same width of 2 mm. The third waveguide was modeled in similar fashion to the glass waveguide, but using a silicon substrate of refractive index, n≈3.48. It has smaller dimensions (250 μm) than the first two waveguides for fabrication purposes.

Because of the change of angle that occurs due to Snell's law, in order to couple the light into, and extract the light out from, the non-free space waveguides, one side 74 of each end (68, 70) of the waveguide has the HR coating 66 removed as shown in FIG. 9.

The Zemax® offers the capability of varying certain parameters of the system to optimize system performance. This is performed via careful construction of a merit function that identifies performance target values, which are then computed in an optimization routine. The software then compares the calculated values to the target values set in the merit function editor and iteratively varies the allowed parameters until a minimum merit function value is obtained.

Proper building of the merit function is very important in getting a well-performing and realistic system. In the system of the present invention, a high and constant dispersion throughout the spectral range of interest is preferred. It is also desirable to have the components configured such that they can be easily purchased and implemented into the system that is in use in our simulation. Operands such as the time of propagation, dispersion, beta values, and other quantities of interest were calculated from Zemax® outputs and subsequent processing on merit function values in an office spreadsheet program.

Since dispersion is the primary objective of the device of the present invention, there are a few merit function operands of significance. First, tracing the total optical path length that each wavelength travels was obtained via Zemax® and then transformed to time of flight (TOF) data in our calculations through knowledge of the index of refraction and therefore speed of travel.

In order to optimize for the dispersion value, the merit functions algebraically manipulated, and the difference in optical path lengths between subsequent wavelengths is obtained, and then this value is maximized. This will maximize the effective dispersion, since it is a scalar multiple of the difference in path length.

Next, the dispersion curve is flattened to eliminate higher-order effects. This is implemented in the merit function by assuring that the optical path difference between wavelengths is uniform throughout the spectrum. To achieve this goal, an equalization operand is used that attempts to make the path difference between sequential wavelengths the same. Both of these operations are arbitrarily weighted 1 in the merit function as the primary targets for the optimization routine to satisfy.

Next, several constraints are placed upon our merit function for actual building of the system. In order to allow for implementation, all components used must obviously not overlap. This provision can be met by defining each individual minimum edge thickness value to be zero in the merit function. If the optimization tends towards extremely minimal spacing values, this minimum edge thickness can be increased. However, too many restraints should not be placed which might prevent the optimization from obtaining the most favorable results. Finally, the radius curvature value is restrained from being too extreme.

The final step in running the optimization routine is defining the parameters, which are to be made variable for Zemax® to alter in search of a better performing system. For our system, all thickness values (the distance between objects) are made variable, as well as the radius of curvature of the dispersion slope equalizer 56, and the horizontal, vertical and angular positioning of each component. All other quantities, including the groove 52 spacing of the diffraction grating 50, were considered fixed and were not changed by Zemax® in the optimization routine.

4.0 Dispersion Results

For the free space version of the waveguide, it is possible to achieve the maximum spread of the angles incident into the waveguide because there is no Snell's law refraction at the interface. Thus, the incident angles, with respect to the normal of the side faces of the waveguide 58, range between 1.5° and 3°. These numbers correspond to the smallest wavelength (1525 nm) matching up with the smallest incident angle (1.5°), therefore making the dispersion parameter value negative, since the smaller wavelength will propagate slower in the waveguide (or equivalently, travel a longer distance). Results regarding the opposite case, where larger wavelengths have longer travel times in the waveguide, will not be discussed here, but it is believed that this possibility does exist.

From FIG. 7, it can be found that an angle of 1.5° corresponds to a length enhancement factor, γ≈35. For a 10 cm waveguide, this would translate to a total travel distance of 350 cm for λ=1525. As expected from geometrical ray tracing, simulation data matches closely with this result. Further progression from this point indicates that there is an approximate change in total travel distance per wavelength of OPD=4.0 cm/nm. This corresponds to an average dispersion value of D=−13.3 ps/nm*cm.

As mentioned above, processing of data was mostly done through a program outside of Zemax® . Optical path lengths were extracted from Zemax® and then sequentially converted to Time of Flight (TOF) for the respective wavelengths by the following equation.

$$T O F = \frac{L \cdot n ( λ )}{c} \qquad ( 4.1 )$$

There are two important pieces of information to be noted at this time. The first is that the time of flight is dependent upon the refractive index of the material. This means that all light that travels inside the waveguide is slowed down by the index. Consequently, a larger dispersion is created in higher index materials. Wavelengths that travel a further distance within the waveguide, and therefore already have a longer time of flight, are in the high index material longer, which causes further temporal separation of wavelengths. In the free space version of our device, the assumption is that the index of refraction is n=1, thus dispersion is lowest in this device. The device is thus presented in three versions, in an effort to maximize the accumulated dispersion by increasing the index.

The next important point is that the wavelength dependency of the refractive index, n(λ), has been included in Eq. (4.1) and all subsequent calculations. As already described, this is known as the material dispersion. This effect has been included through the application of the Sellmeier equations, which describe the index change with wavelength. The form of this equation used in our calculations is given in Eq. (4.2).

$${n}^{2} - 1 = \frac{{K}_{1} {λ}^{2}}{{λ}^{2} - {L}_{1}} + \frac{{K}_{2} {λ}^{2}}{{λ}^{2} - {L}_{2}} + \frac{{K}_{3} {λ}^{2}}{{λ}^{2} - {L}_{3}} \qquad ( 4.2 )$$

Where the dispersion coefficients K₁, K₂, K₃, L₁, L₂, and L₃ are imported from the Zemax® glass catalog. The interpretation of this is that each wavelength will be slowed by a different amount in the medium. In the free space waveguide this is negligible, and it is assumed that all wavelengths see the same refractive index and travel at the speed of light in a vacuum. However, in the glass and silicon waveguides, this has an important effect. The main effect upon our results is the shape of the dispersion curve. Since this material dispersion is being added in the calculations and is not included in the actual simulation, the dispersion slope equalizer cannot completely flatten the curve.

Once time of flight has been calculated, its variation over wavelength to yield the dispersion value becomes of interest. Since discrete values for wavelengths have been sampled, a first order approximation of the derivative, with respect to wavelength is taken:

$$D = \frac{T O {F}_{1} - T O {F}_{2}}{{λ}_{1} - {λ}_{2}} \qquad ( 4.3 )$$

In order to obtain this data, the optical path lengths of many wavelengths were generated in Zemax® , not just the 8 wavelength values that are discussed in above.

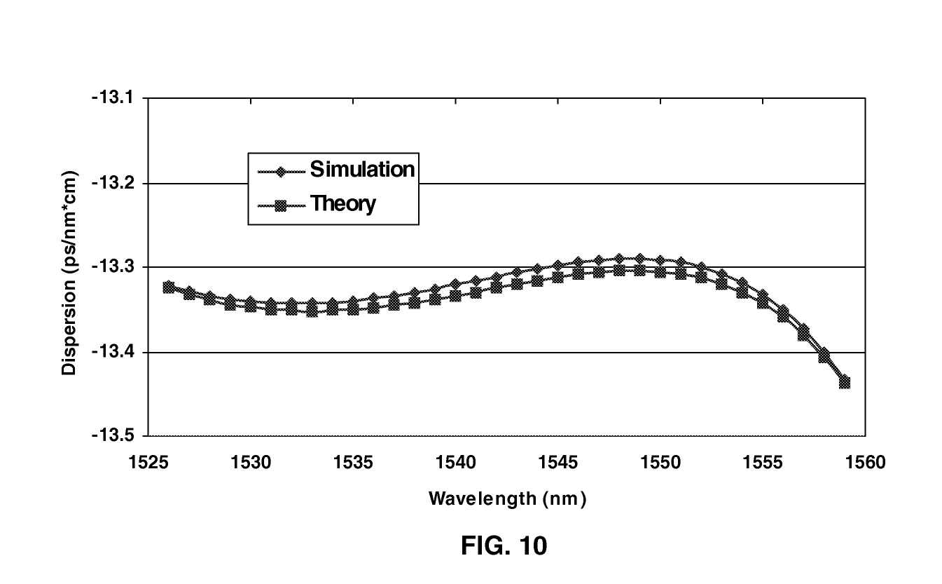

To demonstrate agreement between the simulation results obtained through this method and the predicted theory outlined by Eq. (2.7), both are charted in FIG. 10. For the theoretical calculations, the angles inside the waveguide, for each wavelength, are used to generate the length enhancement factor values. Also, the angular dispersion is a local value, which is taken after the dispersion slope equalizer.

As expected, the data generated using the glass waveguide yields higher dispersion values. Since there is now an interface of two materials with different refractive indices, refraction will occur. The end portion of the waveguide 58 is uncoated, so direct application of Snell's law gives the results of this refraction. After striking the dispersion slope equalizer 56, the light is incident in air outside the waveguide with an angular spread of approximately 2.5° to approximately 4°. Upon refraction from the air-waveguide interface, each angle is reduced in the higher index waveguide. The new angular spread ranges from approximately 1.7° to approximately 2.7°, thus not only are the angles reduced, but the angular dispersion is also reduced. Consequently, the optical path difference between wavelengths is decreased to a value of OPD=3.75 cm/nm. The optical path lengths approach similar values as in the free space case, with the length enhancement factors ranging from γ=35 to γ=22 for the ends of the spectrum λ=1525 nm and λ=1560 nm, respectively. The measured dispersion is increased by the presence of the higher index waveguide as compared to the free space waveguide. However, since the optical path difference has been reduced, the achieved dispersion value is not increased by the full multiplicative ratio of the refractive indices of the glass waveguide to the free-space waveguide. A typical value of D=−18.8 ps/nm*cm is obtained.

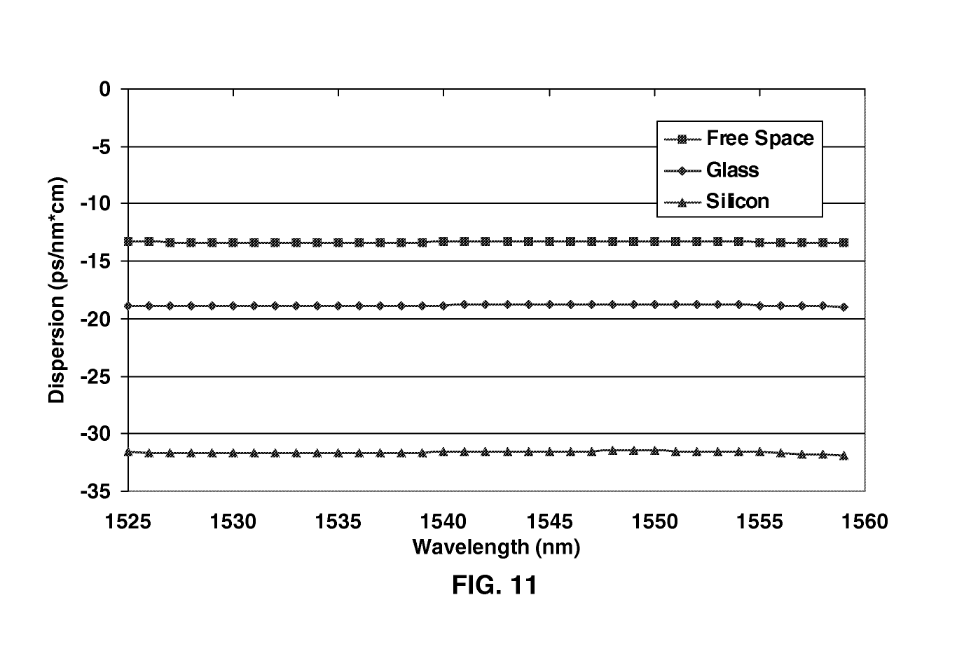

As expected, the silicon waveguide obtained the highest dispersion values. Again refraction occurs at the interface and the angular spread is reduced substantially. Angles outside the waveguide range from approximately 5.8° to approximately 7.9° and are reduced inside the waveguide to approximately 1.6° to approximately 2.3°. This corresponds to length enhancement factors in the range of γ=35-25. The optical path length of the shortest wavelength has a comparable value to those previously obtained, however since the angular dispersion is less than in the other waveguides, the nominal change in optical path lengths is OPD=2.72 cm/nm. With such a large refractive index, an average value of D=−31.6 ps/nm*cm is obtained for this waveguide. The dispersion for each waveguide is charted in FIG. 11. Note that all values are given in units of ps/nm*cm, therefore this is the accumulated dispersion per unit length of the waveguide.

4.1 Higher Order Results

As can be inferred from FIG. 11, the dispersion curves are relatively flat. One of the most attractive features of the chromomodal dispersion device of the present invention is the fact that the dispersion has very little wavelength dependence for broadband operation. The free-space, glass, and silicon waveguides have average values of dD/dλ=−0.0036,−0.0044, −0.009 ps/cm*nm², respectively. The results were obtained again by taking first order approximations of the derivative of the dispersion parameter, as indicated in Eq. (4.4).

$$\frac{d D}{d λ} = \frac{{D}_{λ 1} - {D}_{λ 2}}{{λ}_{1} - {λ}_{2}} \qquad ( 4.4 )$$

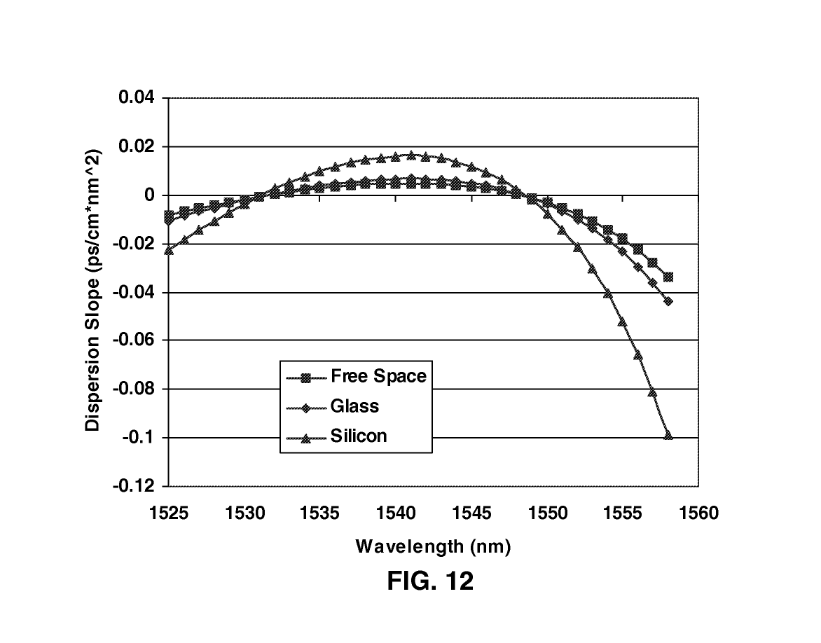

The dispersion slope plots are shown in FIG. 12. Again, material dispersion has been included.

4.3 Comparison with Other Dispersive Devices

Now that the results have been presented for the chromomodal dispersion device 40, it is important to compare them with other dispersive devices. The two that will be used are the single mode fiber (SMF) and the dispersion compensating fiber (DCF). These are chosen because the SMF is the standard fiber used in a very large amount of telecommunications applications, and the DCF has been engineered to specifically have high dispersion characteristics. The SMF used for comparison is the Corning SMF-28®, which has dispersion characteristics given by Eq. (4.5).

$$D = \frac{{S}_{0}}{4} [ λ - \frac{{λ}_{0}^{4}}{{λ}^{3}} ] ( \frac{ps}{nm \cdot km} ) \qquad ( 4.5 )$$

Where normally, S₀=0.086 ps/nm²km and λ₀=1313 nm. Taking the derivative of this equation gives us the dispersion slope.

$$\frac{d D}{d λ} = \frac{{s}_{0}}{4} [ 1 + 3 \frac{{λ}_{0}^{4}}{{λ}^{4}} ] ( \frac{ps}{{nm}^{2} \cdot km} ) \qquad ( 4.6 )$$

The DCF is engineered to specifically compensate for the SMF. Thus, the equations are exactly the same as the SMF except with a negative multiplicative factor. There are many different types of DCF, so for purposes of comparison, we will assume a multiplicative factor of −6. In other words, each kilometer of DCF fiber will compensate for 6 kilometers of SMF.

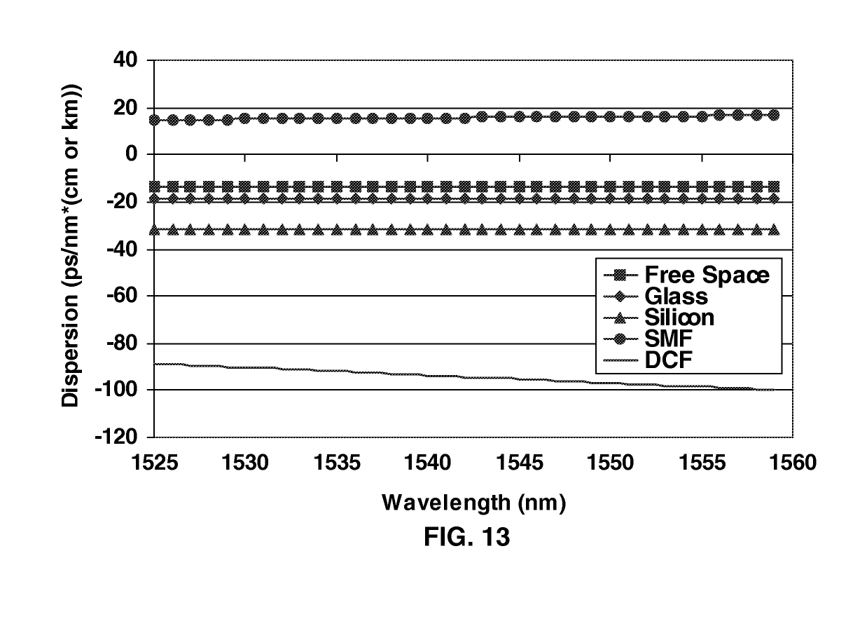

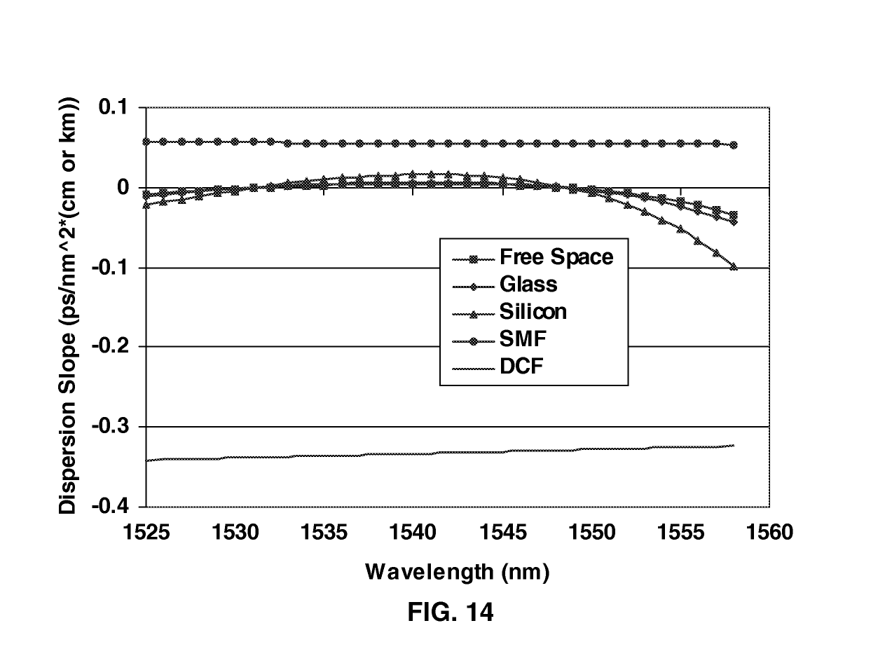

The dispersion characteristics of all three waveguides used in the chromomodal dispersion device are charted with the SMF and DCF in FIG. 13, and the dispersion slope is charted in FIG. 14. All values are charted per unit length. In the chromomodal device 40, the unit length is per centimeter of the waveguide. For the SMF and DCF fibers, the unit length is per kilometer.

It is clear from FIGS. 13 and 14 that the dispersion values of the chromomodal dispersion device are similar (on an absolute scale) to the SMF, with the glass and silicon versions having a larger value. The DCF is very efficient in production of dispersion and obtains larger values than all three versions of our device. However, the dispersion slope of the chromomodal device is 5-10 times smaller than that of the SMF, and 30-60 times smaller than the DCF.

Another attractive feature chromatic device 40 is the expected insertion loss. Under the assumption that the side faces of the waveguide 58 are HR coated, the loss does not scale with length. The assumption of near 100% reflectivity of the side faces is critical to achieve a low loss device. It is also important since different wavelengths will reflect off of the sides a different number of times, thus poor reflectivity would lead to a wavelength dependency of the attenuation. While it is difficult to accurately predict the losses inherent in the system through simulation, a fair estimate can be made. The normal loss of an unblazed, plane-ruled diffraction grating operating in the first order is 3 dB. Half of the light is lost to the zeroth order, but use of a blazed grating allows this loss to be reduced. Assuming an additional loss of 2-3 dB from the collimation of light, reflection from the spherical mirror, and coupling into the waveguide, a final loss estimate of α≈5 dB is predicted. The loss of standard SMF and DCF is 0.2 dB/km and 0.6 dB/km, respectively. Thus, the loss in fibers scales with length.

In order to include loss estimates in the numerical comparison to other dispersive devices, we use the following figure of merit in telecommunications:

$$FOM 1 = \frac{D}{α} ( \frac{ps}{nm \cdot dB} ) \qquad ( 4.7 )$$

In order to include the dispersion slope into this calculation, a second figure of merit is defined.

$$FOM 2 = \frac{D}{α \cdot \frac{\partial D}{\partial λ}} ( \frac{nm}{dB} ) \qquad ( 4.8 )$$

Comparison of all versions of the device proposed here with the SMF and DCF are tabulated below in Table 1. Since the assumption has been made that the loss does not scale with length for our device, we will compare 100 km of fiber to 100 cm of the waveguide in our system for our figures of merit to have similar units. The values for table 1 were made at an operating point of λ=1550 nm.

It is apparent from Table 1 that the values of interest are greatly enhanced in the chromomodal dispersion device of the present invention. The dispersion to loss ratio (FOM1) is significantly higher for all versions of the chromomodal dispersion device 40 than for existing fibers. Even more significant is this ratio when divided by the dispersion slope (FOM2), where the chromomodal dispersion device 40 shows a 50-60 times improvement over SMF and 160-200 times improvement over DCF.

There are several qualifying points to the numbers presented above. First, the distances of 100 cm of waveguide and 100 km of fiber are completely arbitrary. For example, if longer distances of the waveguide are used, the ratios become even higher. Correspondingly, if shorter distances had been chosen, then the dispersion to loss ratio would not have been as high.

It is important to note that the SMF and DCF were not contemplated under the same objectives of the chromomodal dispersion device of the present invention. Low dispersion is usually desirable for fiber optic cable, so the SMF does not maximize this value. Although DCF fiber does have higher dispersion, it is not designed to have a small dispersion slope. It is designed to exactly cancel out the SMF, so this number is not minimized in the DCF design.

Finally, in the light of this qualifying information, it is still important to realize that the propagation distance in the fiber considered here is 100,000 times further than that in the waveguide. Thus, the device of the present invention has vast advantages when considering the amount of space required for this propagation length.

The chromomodal dispersion device of the present invention also has several qualitative advantages compared to a Fabry-Perot resonator. Although there is some similarity between these devices by the repeated reflection of two closely positioned mirrors, there are several key distinctions. The Fabry-Perot resonator relies upon interference effects that occur from two carefully positioned mirrors. It acts as a very narrow-band filter, since the mirror position only satisfies constructive interference for one wavelength. In the chromomodal device of the present invention, interference is avoided since the light is incident with an off-axis angle. In fact, the mirror separation distance is irrelevant for the correct mathematical analysis of the system. The length enhancement factor, γ, is independent of the separation distance and is solely dependent upon the angle of incidence, as seen in Eq. (3.4). It can therefore provide broadband operation, where the only requirement on the positioning of the mirrors is that they are parallel.

The successful simulation of a novel dispersion-creating device has been demonstrated in the aforementioned text. A mathematical basis for the origin of dispersion in materials using wave theory was used for subsequent analysis and derivation of applicable equations to describe the device of the present invention.

It was shown that by using the angular chromatic dispersion created by a diffraction grating and transforming it into modal dispersion in a waveguide, large temporal separation between wavelengths can be produced. In addition, this dispersion has been controlled to be relatively constant across the entire C-band spectrum. This was accomplished in a low-loss manner that provides acceptable insertion loss and does not scale with length.

The chromomodal dispersion device of the present invention has a number of possible applications. The usual effort is to directly compensate for the dispersion created in an optical fiber, which would include a dispersion slope. As a result, a device that provides constant temporal spreading of a pulse is highly desirable in many applications. For example, the device may be used to counter the effects of dispersion in fiber-optic cables such as SMF. The device may be placed at various locations along a fiber-optic transmission line to have a highly negative dispersion and thus counter the dispersion accumulated along the line, similar to that of DCF, however without higher order effects, and long lengths of cable.

Other applications include pulse chirping, and use in a photonic time-stretched analog-to-digital converter, such as that described in U.S. Pat. No. 6,288,659, and the waveform generator disclosed in U.S. Pat. No. 6,724,783, both herein incorporated by reference in their entirety. This innovative A/D converter slows down an analog signal prior to digitization to increase the effective sampling rate. It can be implemented through mapping of the time-scale of an analog signal into wavelengths. This requires a linear group velocity dispersion to stretch the signal in time. However, higher-order dispersive effects can cause distortion in the RF signal. Therefore, system of the present invention would be aptly suited for such application. Thus, the chromomodal dispersion device is an effective tool for providing low loss and high dispersion with minimal wavelength dependence for many current and future telecommunication applications.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

TABLE 1
Figure of Merit Comparison

| | FOM1 (ps/nm/dB) | FOM2 (nm/dB) |
|---|---|---|
| Free Space | −265.8335467 | 858.8204178 |
| Glass | −375.6018088 | 991.9441036 |
| Silicon | −630.1689248 | 825.6593388 |
| SMF | 80.82796609 | 14.78498676 |
| DCF | −161.6559322 | 4.928328921 |

What is claimed is:

1. An apparatus for chromatically dispersing a light wave, comprising:
a spatially diffractive element;
said spatially diffractive element configured to chromatically disperse the light wave into a plurality of spectral components; and
a multimode waveguide coupled to the spatially diffractive element;
wherein the multimode waveguide is configured to transform the dispersed light wave into a plurality of multimode waves; and
wherein the plurality of multimode waves correspond to the plurality of spectral components.

2. An apparatus as recited in claim 1:
wherein the multimode waveguide comprises an entrance port and an exit port; and
wherein the multimode waveguide is configured to propagate the multimode waves of each spectral component from the entrance port to the exit port such that multimode waves of different wavelengths arrive at the exit port at separate times.

3. An apparatus as recited in claim 2, further comprising:
a dispersion slope equalizer positioned between the spatially diffractive element and the multimode waveguide.

4. An apparatus as recited in claim 3, wherein the dispersion slope equalizer is configured to flatten a dispersion curve corresponding to the multimode waves prior to directing the multimode waves into the entrance port of the multimode waveguide.

5. An apparatus as recited in claim 3, wherein the dispersion slope equalizer comprises a curvilinear surface.

6. An apparatus as recited in claim 5, wherein the dispersion slope equalizer comprises a convex spherical surface.

7. An apparatus as recited in claim 4:
wherein the multimode waves comprise higher-order dispersion effects; and
wherein the dispersion slope equalizer removes at least some of said higher-order dispersion effects.

8. An apparatus as recited in claim 7:
wherein at least some of the higher-order dispersion effects comprise non-uniform spread of multimode waves of different wavelengths; and
wherein the dispersion slope equalizer controls the angular spread of said wavelengths.

9. An apparatus as recited in claim 8, wherein the dispersion slope equalizer affects a substantially constant angular spread between said wavelengths to flatten said dispersion curve.

10. An apparatus as recited in claim 3, wherein the spatially diffractive element comprises a diffraction grating.

11. An apparatus as recited in claim 3:
wherein the multimode waveguide comprises at least two parallel inner surfaces; and
wherein said inner surfaces are configured to reflect the plurality of multimode waves incident on said inner surfaces.

12. An apparatus as recited in claim 11:
wherein the multimode waveguide is configured such that the multimode waves are incident on said inner surfaces at a reflection angle θ; and
wherein the reflection angle θ may be varied to change an enhancement factor for the dispersion between multimode waves of different wavelengths.

13. An apparatus as recited in claim 11, wherein the multimode waveguide has a HR coating.

14. An apparatus as recited in claim 3, further comprising a first optic element configured to collimate the light wave on to the dispersive element.

15. An apparatus as recited in claim 3, wherein an orientation of the spatially diffractive element is adjustable to tune dispersion of the light wave.

16. An apparatus for controlling dispersive effects of a light wave traveling in an optical element; comprising:
a spatially diffractive element;
said spatially diffractive element configured to chromatically disperse the light wave into a plurality of spectral components;
a multimode waveguide coupled to the spatially diffractive element; and
a dispersion slope equalizer positioned between the spatially diffractive element and the multimode waveguide;
wherein the multimode waveguide is configured to transform the dispersed light wave into a plurality of multimode waves; and
wherein the plurality of multimode waves correspond to the plurality of spectral components.

17. An apparatus as recited in claim 16:
wherein the multimode waveguide comprises an entrance port and an exit port; and
wherein the multimode waveguide is configured to propagate the multimode waves of each spectral component from the entrance port to the exit port such that multimode waves of different wavelengths arrive at the exit port at separate times.

18. An apparatus as recited in claim 17, wherein the dispersion slope equalizer is configured to flatten a dispersion curve corresponding to the multimode waves prior to directing the multimode waves into the entrance port of the multimode waveguide.

19. An apparatus as recited in claim 16, wherein the optical element comprises a first optical fiber.

20. An apparatus as recited in claim 19:
wherein the light wave comprises dispersive effects as a result of traveling along the first optic fiber; and
wherein the multimode waveguide is configured to counteract said dispersive effects.

21. An apparatus as recited in claim 19, further comprising:
a collimating lens;
wherein the light wave is collimated from the optical fiber to the dispersive element.

22. An apparatus as recited in claim 21, further comprising;
an output coupling coupled to the multimode waveguide;
said output coupling configured to collect and focus the multimode waves into a second optical fiber.

23. An apparatus as recited in claim 17:
wherein the multimode waves comprise higher-order dispersion effects; and
wherein the dispersion slope equalizer removes at least some of said higher-order dispersion effects.

24. An apparatus as recited in claim 17:
wherein the multimode waveguide comprises at least two parallel inner surfaces;
said inner surfaces configured to reflect the plurality of multimode waves incident on said inner surfaces.

25. An apparatus as recited in claim 24:
wherein the multimode waveguide is configured such that the multimode waves are incident on said inner surfaces at a reflection angle θ; and
wherein the reflection angle θ may be varied to change an enhancement factor for the dispersion between multimode waves of different wavelengths.

26. An apparatus as recited in claim 25, wherein an angular orientation of the spatially diffractive element is adjustable to tune the dispersion enhancement factor.

27. An apparatus as recited in claim 25, wherein the reflection angle θ ranges between 1.5 degrees and 3 degrees.

28. An apparatus as recited in claim 25, wherein the light wave has a wavelength ranging from 1525 nm to 1560 nm.

29. A method for chromatically dispersing a light wave, comprising:
directing the light wave at a spatially diffractive element;
chromatically dispersing the light wave into a plurality of spectral components; and
transforming the dispersed light wave into a plurality of multimode waves;
wherein the plurality of multimode waves correspond to the plurality of spectral components.

30. A method as recited in claim 29, wherein transforming the dispersed light wave into a plurality of multimode waves comprises propagating each spectral component along a waveguide such that multimode waves of different wavelengths exit the waveguide at separate times.

31. A method as recited in claim 30, further comprising:
flattening a dispersion curve corresponding to the multimode waves prior to propagating each spectral component.

32. A method as recited in claim 30, wherein flattening the dispersion curve comprises directing a chromatically dispersing the light wave at a curvilinear surface.

33. A method as recited in claim 30:
wherein the multimode waves comprise higher-order dispersion effects; and
flattening the dispersion curve comprises removing at least some of said higher-order dispersion effects.

34. A method as recited in claim 33:
wherein at least some of the higher-order dispersion effects comprise a non-uniform spread of multimode waves of different wavelengths; and
further comprising controlling the angular spread of said wavelengths.

35. A method as recited in claim 29, further comprising collimating the light wave prior to chromatically dispersing the light wave.

36. A method as recited in claim 35, further comprising collecting and focusing the plurality of multimode waves.

37. A method as recited in claim 30, further comprising:
adjusting an angular orientation of the chromatically dispersing the light with respect to the waveguide to tune the dispersion of the light wave.
